(19) United States
(12) Patent Application Publication
(10) Pub. No.: US 2018/0189831 A1
(43) Pub. Date: Jul. 5, 2018

(54) DELIVERING PERSONALIZED ADVERTISING

(71) Applicant: International Business Machines Corporation, Armonk, NY (US)

(72) Inventors: Ana Paula APPEL, São Paulo (BR); Heloisa Caroline de Souza Pereira CANDELLO, São Paulo (BR); Carlos Henrique CARDONHA, São Paulo (BR); Marisa Affonso VASCONCELOS, São Paulo (BR)

(21) Appl. No.: 15/399,036

(22) Filed: Jan. 5, 2017

(51) Int. Cl. G06Q 30/02; G06Q 50/00

(52) U.S. Cl. CPC G06Q 30/0255; G06Q 50/01

(57) ABSTRACT

Personalized advertising is delivered to a subject at a time when the state of mind of the subject is most receptive to the receipt of advertising such that the content of the advertising is selected based on the state of mind of the subject at the time of delivery. Activities of a subject to receive the advertisement and indicators of physiological status of the subject are monitored, and the monitored activities and indicators of physiological status are used to determine a current state of mind of the subject. The current state of mind of the subject is used to select a delivery time for the advertisement, and the content for the advertisement that is personalized to the subject is selected based on the current state of mind of the subject at the delivery time. The advertisement containing the content is communicated to the subject at the delivery time.

### FIELD OF THE INVENTION

The present invention relates to advertising and targeted electronic notification of advertisements.

### BACKGROUND OF THE INVENTION

Advertisers attempt to produce advertising that captures the attention and interest of their target consumers, i.e., those most likely to purchase their products and services, preferably at a time when those consumers are likely to make the purchase. Therefore, effective advertisements and advertising campaigns should include content that is relevant to the target audience and should be delivered to members of the target audience when those members are most likely to be receptive to that content.

Widespread availability of personal computing devices such as smartphones and tablet computers combined with a proliferation in the regular use of network based social media places an increased emphasis on personalization and individual targeting of advertisements. Social media in particular facilitates the identification of content that is suitable for individuals or groups of individuals. Even with an identification of relevant or targeted content, proper timing in the delivery of that content is important to increase the probability that the content will be positively received and that the target recipients will purchase the advertised services or products. For example, a target recipient that is in a high stress situation, e.g., a business meeting or a pressing business deadline, is less likely to be receptive to unsolicited advertising. Conversely, when the same recipient is bored during a business meeting or during a business trip is more likely to be receptive to the unsolicited advertisement as a welcome distraction.

### SUMMARY OF THE INVENTION

Exemplary embodiments are directed to systems and methods that improve traditional solutions for digital advertisement by leveraging the data collection and content delivery capabilities of personal computing devices and social media to determine both an optimal time for delivering advertising and targeted advertising content specific to the optimal time. Content and timing take into account user preferences, for example, detected from activity on social media networks, and the state of mind of individuals, which could indicate the current mood of those individuals.

Exemplary embodiments are directed to a method for delivering personalized advertising by monitoring activities of a subject to receive an advertisement and indicators of physiological status of the subject, using the monitored activities and indicators of physiological status to determine a current state of mind of the subject, using the current state of mind of the subject to select a delivery time for the advertisement, selecting content for the advertisement that is personalized to the subject based on the current state of mind of the subject at the delivery time and communicating the advertisement containing the content to the subject at the delivery time. In one embodiment, monitoring the activities and physiological status of the subject includes monitoring at least one of social media, electronic calendars, electronic mail messages, text messages, global positioning data, audio communications, video communications and electronic transactions associated with the subject. In one embodiment, monitoring the activities and physiological status of the subject includes using data capture devices to monitor the activities and physiological status. Suitable data capture devices include, but are not limited to, still cameras, video cameras, microphones, telephone equipment, telephone conferencing equipment, video conference equipment, telephones, cellular telephones, smartphones, tablet computers, electronic mail applications, text message applications, thermostats, thermometers, motion sensors, physiological sensors, activity sensors, biomedical sensors and combinations thereof.

In one embodiment, the current state of mind includes at least one of mood, attentiveness, psychological status, cognitive state, emotional state and temperament. Using the current state of mind of the subject to select the delivery time includes identifying the time such that the current state of mind of the subject produces a threshold level of positive response by the subject to advertising and a threshold level of active interaction by the subject with the communicated advertising. In one embodiment, the method also includes identifying the threshold level of positive response and the threshold level of active interaction and associating a probability of achieving the threshold level of positive response and a probability of achieving the threshold level of interaction with each state of mind in a plurality of states of mind. In one embodiment, the method also includes monitoring a level of actual interaction by the subject with the communicated advertisement and associating the level of actual interaction with the current statement of mind. Associating the probability of achieving the threshold level of positive response and the threshold level of interaction also includes using the level of actual interaction associated with the current state of mind to determine the probability of achieving the threshold level of positive response and the probability of achieving the threshold level of interaction for the current state of mind.

In one embodiment, using the current state of mind of the subject to select the delivery time includes identifying the time such that the current state of mind has a sufficient probability of achieving the threshold level of positive response and a sufficient probability of achieving the threshold level of active interaction. In one embodiment, selecting the content includes identifying content based on a likelihood of being favorably received by the subject given the current state of mind. In one embodiment, selecting content includes using the monitored activities and indicators of physiological status in combination with the current state of mind to select the content personalized to the subject. In one embodiment, communicating the advertisement includes using at least one of speakers, video monitors, lights, haptic systems, kinesthetic systems, graphical user interfaces, smart phones, tablet computers, telephones and cellular telephones to communicate the advertisement.

Exemplary embodiments are also directed to a computing system for delivering personalized advertising. The computing system includes a monitoring system to monitor activities of a subject to receive an advertisement and indicators of physiological status of the subject, a state of mind determination module in communication with the monitoring system to use the monitored activities and indicators of physiological status to determine a current state of mind of the subject, a scheduler in communication with the state of mind determination module to use the current state of mind of the subject to select a delivery time for the advertisement, an advertisement generation system in communication with an advertisement content database, the scheduler and the state of mind determination module to select content for the advertisement from the content database that is personalized to the subject based on the current state of mind of the subject at the delivery time and an output system in communication with the scheduler and the advertisement generation system to communicate the advertisement containing the content to the subject at the delivery time.

In one embodiment, the monitoring system includes at least one data capture device selected from the group consisting of cameras, video cameras, microphones, telephone equipment, telephone conferencing equipment, video conference equipment, telephones, cellular telephones, smartphones, tablet computers, electronic mail applications, text message applications, thermostats, thermometers, motion sensors, physiological sensors, activity sensors, biomedical sensors and combinations thereof. In one embodiment, the current state of mind is at least one of mood, attentiveness, psychological status, cognitive state, emotional state and temperament, and the scheduler identifies the time such that the current state of mind of the subject produces a threshold level of positive response by the subject to advertising and a threshold level of active interaction by the subject with the communicated advertising.

In one embodiment, the computing system includes a threshold value module in communication with the scheduler to identify the threshold level of positive response and the threshold level of active interaction, and a probability module to associate a probability of achieving the threshold level of positive response and a probability of achieving the threshold level of interaction with each state of mind in a plurality of states of mind. In one embodiment, the monitoring system monitors a level of actual interaction by the subject with the communicated advertisement, and the computing system includes an association module to associate the level of actual interaction with the current statement of mind. The probability module uses the level of actual interaction associated with the current state of mind to determine the probability of achieving the threshold level of positive response and the probability of achieving the threshold level of interaction for the current state of mind, and the scheduler identifies the time such that the current state of mind has a sufficient probability of achieving the threshold level of positive response and a sufficient probability of achieving the threshold level of active interaction. In one embodiment, the output system includes speakers, video monitors, lights, haptic systems, kinesthetic systems, graphical user interfaces, smart phones, tablet computers, telephones, cellular telephones and combinations thereof.

### BRIEF DESCRIPTION OF THE DRAWINGS

FIG. 1 is a schematic representation of an embodiment of a computing system for creating and delivering personalized advertising;

FIG. 2 is a flow chart illustrating an embodiment of a method for delivering personalized advertising;

FIG. 3 depicts a cloud computing environment according to an embodiment of the present invention; and

FIG. 4 depicts abstraction model layers according to an embodiment of the present invention.

### DETAILED DESCRIPTION

Exemplary embodiments implement a system for determining the content and timing for personalized notification of content such as advertising content. While focused on advertisements and advertising content, systems and methods in accordance with the present invention can be used to deliver any type of targeted content or notification at an optimal time. At least one database, for example, an advertisement content database is created and maintained. In one embodiment, the advertisement content database is arranged into a plurality of advertising categories. These advertising categories can be created by an advertiser or by the system and can be company specific. Suitable advertising categories include, but are not limited to, clothing, bedding, fashion, education, appliances, music, sports, hunting, automobiles, vacation, healthcare, insurance, electronics and computers. The advertising content includes video, audio and text, and the content is arranged into the advertising categories. A given video or audio clip, given text or a given complete advertisement can be arranged in one or more advertising categories.

Advertising is targeted to one or more subjects. A subject can be an individual person or consumer. In addition, the subject of the advertisement can also be a group of individuals, for example, a business or an audience. Targeting advertising includes personalizing the time for delivering the advertisement and the content of the advertisement. Both the time of delivery and the content of the advertisement are personalized using the current state of mind of the subject at a given time, i.e., the time of delivery. The current state of mind of the subject is determined based on the activities and physiological state of the subject.

In order to determine the state of mind of the subject, information about the current activities of the subject is captured by the system, for example, directly from an electronic schedule or calendar associated with the subject or inferred from posts in social networks. In addition, data such as biometric data are captured so that the physiological status of the subject can be determined, e.g., calm, nervous or sleepy. All of the captured information and data are used to determine the state of mind and in particular the current state of mind of the subject. The current state of mind is then used to select the best delivery time for the advertisement. The best delivery time is a time in which the state of mind of the subject indicates a sufficient probability of positive reaction and lengthy interaction by the subject with the advertisement. In addition, the state of mind of the subject at the selected time of delivery of the advertisement is used to select the content of the advertisement. Therefore, the content of the advertisement is personalized to the subject and to the state of mind of the subject at the time of delivery. Using the state of mind at the time of delivery to control content increases the probability that the content will be desired by or relevant to the subject at the time of delivery.

In order to the improve the selection of the time and content based on state of mind, the system uses feedback to associate actual subject responses and interactions with a given state of mind or current state of mind. Therefore, the system, following delivery of the personalized content advertisement at the selected time of delivery, monitors interactions with the advertisement by the subject. In one embodiment, the system determines a level of interaction, i.e., length of time and speed of interaction, with the targeted personalized advertisement, e.g., ignore (zero interaction), fast inspection, slow inspection and interactive. These levels of interaction can be quantified or assigned a score ranging from high to low. The score is then associated with at least one of the state of mind of the subject, the subject, the content of the advertisement and the category of the content of the advertisement. In one embodiment, values or probabilities are defined by the system or are input into the system to indicate the states of mind, content of advertisement or categories of advertisement in which subjects are more likely to achieve the desired level or the threshold level of interaction with an advertisement, e.g., fast inspection with probability of at least 90% or slow inspection with probability of at least 75%. These threshold values can be used in determining whether or not to deliver an advertisement with a given content to a given subject in a given state of mind.

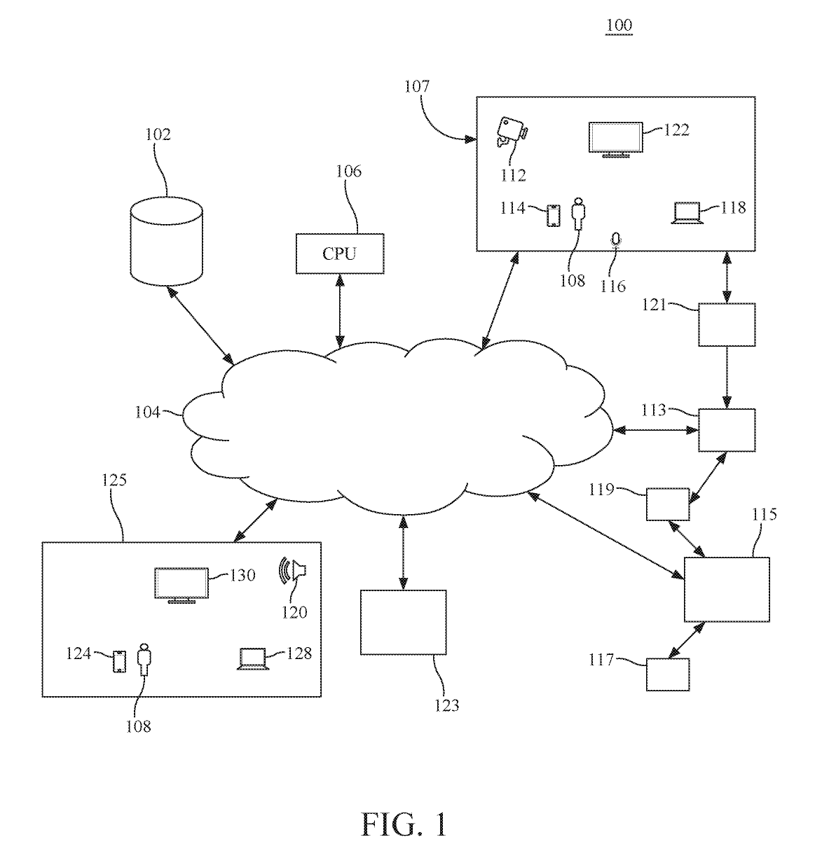

Referring initially to FIG. 1, exemplary embodiments are directed to a system such as a computing system for delivering personalized advertising 100. Suitable computing systems include distributed computing systems and cloud based computing systems. The computing system includes at least one memory 102 such as a hardware memory containing one or more databases including an advertising content database. The databases can also include the software for configuring the computing system, for performing the methods for delivering personalized information and for creating instances of the various systems and modules of the computing system. The computing system includes at least one computer processor 106 that is in communication with the databases or memory and that can execute the software and perform all of the computational functions for operation of the computing system and the delivery of personalized advertising. In one embodiment, the computing system includes a plurality of processors. All of the components, modules and systems of the computing system, including the database and the processor are in communication through one or more local or wide area networks 104.

The computing system includes at least one monitoring system 107 executing on one or more computers or nodes within the computing system. The monitoring system monitors activities or actions of a subject 108 that is to receive an advertisement. The monitoring system also monitors indicators of physiological status of the subject. In order to obtain the desired information and data regarding the activities and physiological status of the subject, the monitoring system includes at least one and preferably a plurality of data capture devices. These data captures devices can be devices in physical proximity to the subject or virtual devices or environments with which the subject interacts. Suitable data capture devices include, but are not limited to, cameras, video cameras 112, microphones 116, telephone equipment, telephone conferencing equipment, video conference equipment 122, telephones, cellular telephones, smartphones 114, laptop or tablet computers 118, electronic mail applications, text message applications, thermostats, thermometers, motion sensors, physiological sensors, activity sensors, biomedical sensors and combinations thereof. In one embodiment, any data capture device or system capable of monitoring social media, electronic calendars, electronic mail messages, text messages, global positioning data, audio communications, video communications and electronic transactions associated with the subject can be used. In one embodiment, the monitored activities and indicators of physiological status are stored in the database, for example, in association with the subject and a given time stamp. The monitoring system also monitors a level of actual interaction by the subject with any advertisement communicated to the subject.

The computing system also includes a state of mind determination module 113 in communication with the monitoring system to receive the monitored activities and indicators of physiological status from the monitoring system. The state of mind determination module uses the monitored activities and indicators of physiological status to determine a current state of mind of the subject. In one embodiment, the state of mind determination module uses a table, e.g., a table stored in the database, that associates activities and indicators, or groupings of activities and indicators, with a given state of mind in a plurality of states of mind. Suitable states of mind include, but are not limited to, mood, attentiveness, psychological status, cognitive state, emotional state and temperament.

The computing system includes a scheduler 115. The scheduler is in communication with the state of mind determination module and receives the current state of mind as determined by the state of mind determination module. The scheduler uses the current state of mind of the subject to select a delivery time for the advertisement. In one embodiment, the scheduler identifies the time such that the current state of mind of the subject produces a threshold level of positive response by the subject to advertising and a threshold level of active interaction by the subject with the communicated advertising. In order to make this determination, the computing system includes a threshold value module 117 in communication with the scheduler. In one embodiment, the computing system through the threshold value module identifies the threshold level of positive response and the threshold level of active interaction. This can be computed internally by the computing system or input from a source external to the computing system. A probability module 119 is also provided in communication with at least one of the scheduler and the state of mind determination module to associate a probability of achieving the threshold level of positive response and a probability of achieving the threshold level of interaction with each state of mind in a plurality of states of mind.

Since the monitoring system continues to monitor the actual interaction of the subject with the communicated advertisement, the computing system includes an association module 121 in communication with the monitoring system and the state of mind determination module. The association module associates the level of actual interaction between the subject and the advertisement with the current statement of mind of the subject at the scheduled time of delivery of the advertisement. The probability module uses the level of actual interaction associated with the current state of mind to determine the probability of achieving the threshold level of positive response and the probability of achieving the threshold level of interaction for the current state of mind. The scheduler identifies the time such that the current state of mind has a sufficient probability of achieving the threshold level of positive response and a sufficient probability of achieving the threshold level of active interaction.

The computing system includes an advertisement generation system 123 in communication with an advertisement content database, the scheduler and the state of mind determination module to select content for the advertisement from the content database that is personalized to the subject based on the current state of mind of the subject at the delivery time. The advertisement generation system and the scheduler are also in communication with an output system 125. The output system communicates the advertisement containing the content to the subject 108 at the selected delivery time. In order to communicate the advertisement, the output system includes at least one of speakers 120, video monitors 130, lights, haptic systems, kinesthetic systems, graphical user interfaces, smart phones 124, computers such as tablet computers 128, telephones and cellular telephones. In one embodiment, one or more of the same devices can be used as data capture devices and advertisement communication devices.

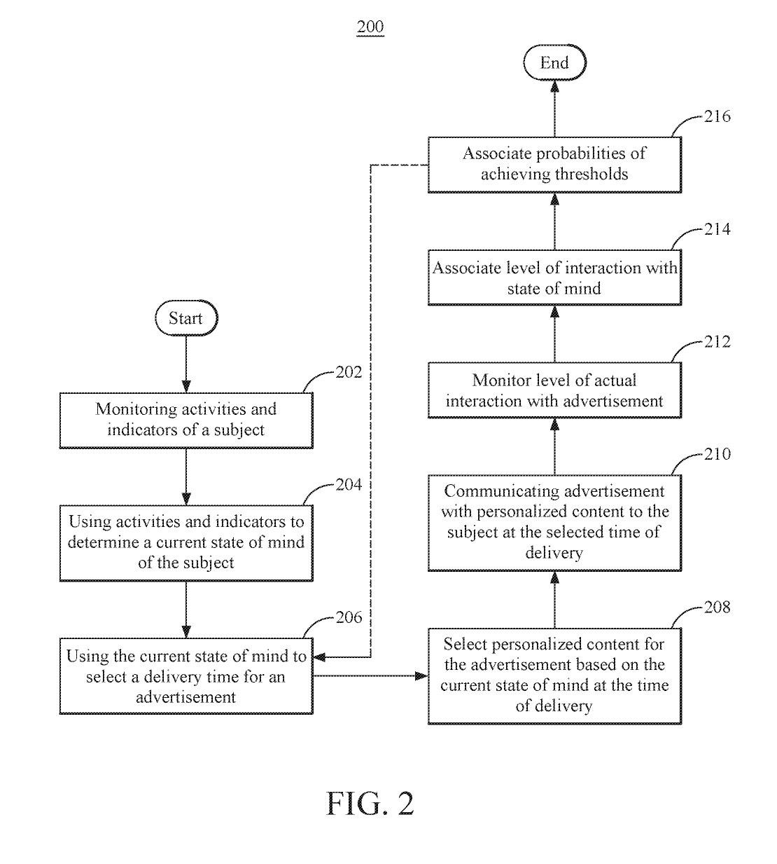

Referring now to FIG. 2, exemplary embodiments are also directed to a method for delivering personalized advertising 200. In one embodiment, all of these steps are performed autonomously by the computing system. Activities of a subject to receive an advertisement and indicators of physiological status of the subject are monitored 202. Monitoring the activities and physiological status of the subject includes monitoring at least one of social media, electronic calendars, electronic mail messages, text messages, global positioning data, audio communications, video communications and electronic transactions associated with the subject. The desired information and data can be monitored or captured using one or more data capture devices. Suitable data capture devices include, but are not limited to, still cameras, video cameras, microphones, telephone equipment, telephone conferencing equipment, video conference equipment, telephones, cellular telephones, smartphones, tablet computers, electronic mail applications, text message applications, thermostats, thermometers, motion sensors, physiological sensors, activity sensors and biomedical sensors.

The monitored activities and indicators of physiological status are used to determine a current state of mind of the subject 204. The current state of mind of the subject includes mood, attentiveness, psychological status, cognitive state, emotional state and temperament. The current state of mind of the subject is used to select a delivery time for the advertisement 206. In one embodiment, selecting the delivery time involves identifying the time such that the current state of mind of the subject produces a threshold level of positive response by the subject to advertising and a threshold level of active interaction by the subject with the communicated advertising. In order to achieve this, the threshold level of positive response and the threshold level of active interaction are identified, and a probability of achieving the threshold level of positive response and a probability of achieving the threshold level of interaction is associated with each state of mind in a plurality of states of mind. Therefore, given the identified current state of mind, the appropriate delivery time can be selected to achieve the desired threshold level of response and interaction.

Having identified the delivery time, which is associated with a current state of mind of the subject, content for the advertisement is selected that is personalized to the subject and that is based on the current state of mind of the subject at the delivery time 208. In one embodiment, the content of the advertisement is identified and selected based on a likelihood of being favorably received by the subject given the current state of mind of that subject at the time of delivery. In addition to the current state of mind of the subject at the time of delivery, the monitored activities and indicators of physiological status can be used in combination with the current state of mind to select the content personalized to the subject.

Having identified the delivery time and content of the advertisement, the advertisement containing the content is communicated to the subject at the delivery time 210. In one embodiment, at least one of speakers, video monitors, lights, haptic systems, kinesthetic systems, graphical user interfaces, smart phones, tablet computers, telephones and cellular telephones are used to communicate the advertisement. Following delivery, a level of actual interaction by the subject with the communicated advertisement is monitored 212. The monitored and captured level of actual interaction is associated with the current statement of mind of the subject at the time of delivery 214. This associated can be stored in a database and can be used to determine and associate the probability of achieving the threshold level of positive response and the threshold level of interaction 216. This is achieved by using the level of actual interaction associated with the current state of mind to determine the probability of achieving the threshold level of positive response and the probability of achieving the threshold level of interaction for the current state of mind. There probabilities and associations can also be stored in the database and in one embodiment are communicated for use in scheduling delivery of advertisements based on the current state of mind. Therefore, in one embodiment, the delivery time is identified such that the current state of mind has a sufficient probability of achieving the threshold level of positive response and a sufficient probability of achieving the threshold level of active interaction.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to apparatus (systems) and computer program products according to embodiments of the invention. It will be understood that each description and illustration can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the block diagram block or blocks.

The schematic illustrations and block diagrams in the Figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams, and combinations of blocks in the block diagrams, can be implemented by special purpose hardware-based systems that perform the specified functions or acts, or combinations of special purpose hardware and computer instructions.

It is to be understood that although a detailed description on cloud computing is provided, implementation of the teachings provided herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources, e.g., networks, network bandwidth, servers, processing, memory, storage, applications, virtual machines, and services, that can be rapidly provisioned and released with minimal management effort or interaction with a provider of the service.

This cloud model may include at least five characteristics, at least three service models, and at least four deployment models. The five characteristics are on-demand self-service, broad network access, resource pooling, rapid elasticity and measured service. Regarding on-demand self-service, a cloud consumer can unilaterally provision computing capabilities, such as server time and network storage, as needed automatically without requiring human interaction with the service's provider. Broad network access refers to capabilities that are available over a network and accessed through standard mechanisms that promote use by heterogeneous thin or thick client platforms, e.g., mobile phones, laptops, and PDAs. For resource pooling, the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction, e.g., country, state, or datacenter. Rapid elasticity refers to capabilities that can be rapidly and elastically provisioned, in some cases automatically, to quickly scale out and rapidly released to quickly scale in. To the consumer, the capabilities available for provisioning often appear to be unlimited and can be purchased in any quantity at any time. For measured service, cloud systems automatically control and optimize resource use by leveraging a metering capability at some level of abstraction appropriate to the type of service, e.g., storage, processing, bandwidth, and active user accounts. Resource usage can be monitored, controlled, and reported, providing transparency for both the provider and consumer of the utilized service.

The three service models are Software as a Service (SaaS), Platform as a Service (PaaS) and Infrastructure as a Service (IaaS). Software as a service provides the capability to the consumer to use the provider's applications running on a cloud infrastructure. The applications are accessible from various client devices through a thin client interface such as a web browser, e.g., web-based e-mail. The consumer does not manage or control the underlying cloud infrastructure including network, servers, operating systems, storage, or even individual application capabilities, with the possible exception of limited user-specific application configuration settings. Platform as a service provides the capability to the consumer to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a service provides the capability to the consumer to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components, e.g., host firewalls.

The Deployment Models are private cloud, community cloud, public cloud and hybrid cloud. The private cloud infrastructure is operated solely for an organization. It may be managed by the organization or a third party and may exist on-premises or off-premises. The community cloud infrastructure is shared by several organizations and supports a specific community that has shared concerns, e.g., mission, security requirements, policy, and compliance considerations. It may be managed by the organizations or a third party and may exist on-premises or off-premises. The public cloud infrastructure is made available to the general public or a large industry group and is owned by an organization selling cloud services. The hybrid cloud infrastructure is a composition of two or more clouds (private, community, or public) that remain unique entities but are bound together by standardized or proprietary technology that enables data and application portability, e.g., cloud bursting for load-balancing between clouds.

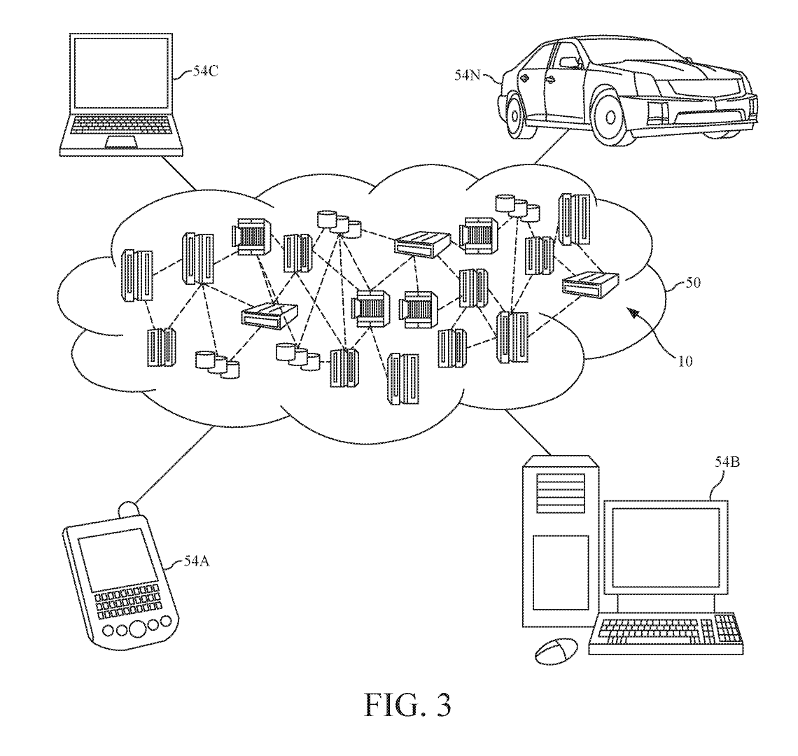

A cloud computing environment is service oriented with a focus on statelessness, low coupling, modularity, and semantic interoperability. At the heart of cloud computing is an infrastructure that includes a network of interconnected nodes. Referring now to FIG. 3, an illustrative cloud computing environment 50 is depicted. As shown, the cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection, e.g., using a web browser.

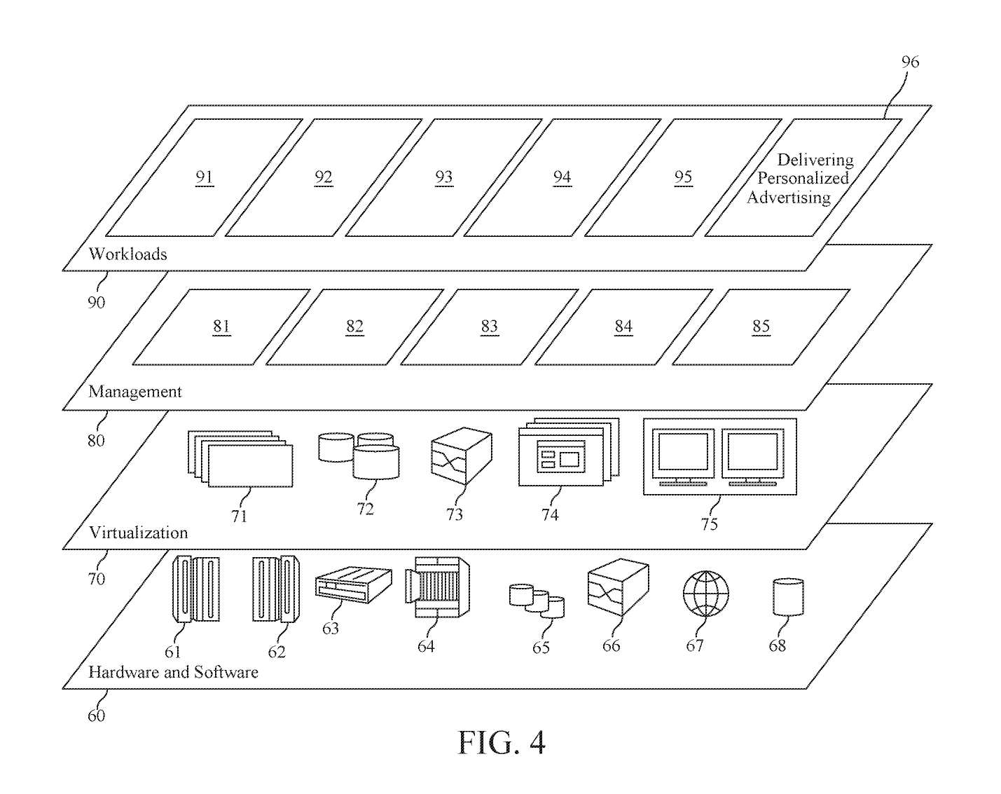

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided. A hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68. A virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and delivering personalized advertising 96.

Methods and systems in accordance with exemplary embodiments of the present invention can take the form of an entirely hardware embodiment, an entirely software embodiment or an embodiment containing both hardware and software elements. In a preferred embodiment, the invention is implemented in software, which includes but is not limited to firmware, resident software and microcode. In addition, exemplary methods and systems can take the form of a computer program product accessible from a computer-usable or computer-readable medium providing program code for use by or in connection with a computer, logical processing unit or any instruction execution system. For the purposes of this description, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

Suitable data processing systems for storing and/or executing program code include, but are not limited to, at least one processor coupled directly or indirectly to memory elements through a system bus. The memory elements include local memory employed during actual execution of the program code, bulk storage, and cache memories, which provide temporary storage of at least some program code in order to reduce the number of times code must be retrieved from bulk storage during execution. Input/output or I/O devices, including but not limited to keyboards, displays and pointing devices, can be coupled to the system either directly or through intervening I/O controllers. Exemplary embodiments of the methods and systems in accordance with the present invention also include network adapters coupled to the system to enable the data processing system to become coupled to other data processing systems or remote printers or storage devices through intervening private or public networks. Suitable currently available types of network adapters include, but are not limited to, modems, cable modems, DSL modems, Ethernet cards and combinations thereof.

In one embodiment, the present invention is directed to a machine-readable or computer-readable medium containing a machine-executable or computer-executable code that when read by a machine or computer causes the machine or computer to perform a method for delivering personalized advertising in accordance with exemplary embodiments of the present invention and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages. The computer-executable code can be stored on any suitable storage medium or database, including databases disposed within, in communication with and accessible by computer networks utilized by systems in accordance with the present invention and can be executed on any suitable hardware platform as are known and available in the art including the control systems used to control the presentations of the present invention.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s) and steps or elements from methods in accordance with the present invention can be executed or performed in any suitable order. Therefore, it will be understood that the appended claims are intended to cover all such modifications and embodiments, which would come within the spirit and scope of the present invention.

What is claimed is:

1. A method for delivering personalized advertising, the method comprising:
monitoring activities of a subject to receive an advertisement and indicators of physiological status of the subject;
using the monitored activities and indicators of physiological status to determine a current state of mind of the subject;
using the current state of mind of the subject to select a delivery time for the advertisement;
selecting content for the advertisement that is personalized to the subject based on the current state of mind of the subject at the delivery time; and
communicating the advertisement containing the content to the subject at the delivery time.

2. The method of claim 1, wherein monitoring the activities and physiological status of the subject comprises monitoring at least one of social media, electronic calendars, electronic mail messages, text messages, global positioning data, audio communications, video communications and electronic transactions associated with the subject.

3. The method of claim 1, wherein monitoring the activities and physiological status of the subject comprises using data capture devices to monitor the activities and physiological status.

4. The method of claim 1, wherein the data capture devices comprise still cameras, video cameras, microphones, telephone equipment, telephone conferencing equipment, video conference equipment, telephones, cellular telephones, smartphones, tablet computers, electronic mail applications, text message applications, thermostats, thermometers, motion sensors, physiological sensors, activity sensors, biomedical sensors or combinations thereof.

5. The method of claim 1, wherein the current state of mind comprises at least one of mood, attentiveness, psychological status, cognitive state, emotional state and temperament.

6. The method of claim 1, wherein using the current state of mind of the subject to select the delivery time comprises identifying the time such that the current state of mind of the subject produces a threshold level of positive response by the subject to advertising and a threshold level of active interaction by the subject with the communicated advertising.

7. The method of claim 6, wherein the method further comprises:
identifying the threshold level of positive response and the threshold level of active interaction; and
associating a probability of achieving the threshold level of positive response and a probability of achieving the threshold level of interaction with each state of mind in a plurality of states of mind.

8. The method of claim 7, wherein:
the method further comprises:
monitoring a level of actual interaction by the subject with the communicated advertisement; and
associating the level of actual interaction with the current statement of mind; and
associating the probability of achieving the threshold level of positive response and the threshold level of interaction further comprises using the level of actual interaction associated with the current state of mind to determine the probability of achieving the threshold level of positive response and the probability of achieving the threshold level of interaction for the current state of mind.

9. The method of claim 7, wherein using the current state of mind of the subject to select the delivery time further comprises identifying the time such that the current state of mind has a sufficient probability of achieving the threshold level of positive response and a sufficient probability of achieving the threshold level of active interaction.

10. The method of claim 1, wherein selecting the content further comprises identifying content based on a likelihood of being favorably received by the subject given the current state of mind.

11. The method of claim 1, wherein selecting content further comprises using the monitored activities and indicators of physiological status in combination with the current state of mind to select the content personalized to the subject.

12. The method of claim 1, wherein communicating the advertisement comprises using at least one of speakers, video monitors, lights, haptic systems, kinesthetic systems, graphical user interfaces, smart phones, tablet computers, telephones and cellular telephones to communicate the advertisement.

13. A computing system for delivering personalized advertising, the computing system comprising:
a monitoring system to monitor activities of a subject to receive an advertisement and indicators of physiological status of the subject;
a state of mind determination module in communication with the monitoring system to use the monitored activities and indicators of physiological status to determine a current state of mind of the subject;
a scheduler in communication with the state of mind determination module to use the current state of mind of the subject to select a delivery time for the advertisement;
an advertisement generation system in communication with an advertisement content database, the scheduler and the state of mind determination module to select content for the advertisement from the content database that is personalized to the subject based on the current state of mind of the subject at the delivery time; and
an output system in communication with the scheduler and the advertisement generation system to communicate the advertisement containing the content to the subject at the delivery time.

14. The computing system of claim 13, wherein the monitoring system comprises at least one data capture device selected from the group consisting of cameras, video cameras, microphones, telephone equipment, telephone conferencing equipment, video conference equipment, telephones, cellular telephones, smartphones, tablet computers, electronic mail applications, text message applications, thermostats, thermometers, motion sensors, physiological sensors, activity sensors, biomedical sensors and combinations thereof.

15. The computing system of claim 13, wherein:
the current state of mind comprises at least one of mood, attentiveness, psychological status, cognitive state, emotional state and temperament; and
the scheduler identifies the time such that the current state of mind of the subject produces a threshold level of positive response by the subject to advertising and a threshold level of active interaction by the subject with the communicated advertising.

16. The computing system of claim 15, wherein the computing system comprises:
a threshold value module in communication with the scheduler to identify the threshold level of positive response and the threshold level of active interaction; and
a probability module to associate a probability of achieving the threshold level of positive response and a probability of achieving the threshold level of interaction with each state of mind in a plurality of states of mind.

17. The computing system of claim 16, wherein:
the monitoring system monitors a level of actual interaction by the subject with the communicated advertisement;
the computing system comprises an association module to associate the level of actual interaction with the current statement of mind;
the probability module uses the level of actual interaction associated with the current state of mind to determine the probability of achieving the threshold level of positive response and the probability of achieving the threshold level of interaction for the current state of mind; and
the scheduler identifies the time such that the current state of mind has a sufficient probability of achieving the threshold level of positive response and a sufficient probability of achieving the threshold level of active interaction.

18. The computing system of claim 13, wherein the output system comprises speakers, video monitors, lights, haptic systems, kinesthetic systems, graphical user interfaces, smart phones, tablet computers, telephones, cellular telephones or combinations thereof.

19. A computer-readable storage medium containing a computer-readable code that when read by a computer causes the computer to perform a method for delivering personalized advertising, the method comprising:
monitoring activities of a subject to receive an advertisement and indicators of physiological status of the subject;
using the monitored activities and indicators of physiological status to determine a current state of mind of the subject;
using the current state of mind of the subject to select a delivery time for the advertisement;
selecting content for the advertisement that is personalized to the subject based on the current state of mind of the subject at the delivery time; and
communicating the advertisement containing the content to the subject at the delivery time.

20. The computer-readable medium of claim 19, wherein:
the current state of mind comprises at least one of mood, attentiveness, psychological status, cognitive state, emotional state and temperament;
using the current state of mind of the subject to select the delivery time comprises identifying the time such that the current state of mind of the subject produces a threshold level of positive response by the subject to advertising and a threshold level of active interaction by the subject with the communicated advertising;
the method further comprises:
identifying the threshold level of positive response and the threshold level of active interaction;
monitoring a level of actual interaction by the subject with the communicated advertisement;
associating the level of actual interaction with the current statement of mind; and
associating a probability of achieving the threshold level of positive response and a probability of achieving the threshold level of interaction with each state of mind in a plurality of states of mind by using the level of actual interaction associated with the current state of mind to determine the probability of achieving the threshold level of positive response and the probability of achieving the threshold level of interaction for the current state of mind; and
using the current state of mind of the subject to select the delivery time further comprises identifying the time such that the current state of mind has a sufficient probability of achieving the threshold level of positive response and a sufficient probability of achieving the threshold level of active interaction.
